(19) United States
(12) Patent Application Publication
(10) Pub. No.: US 2016/0256012 A1
(43) Pub. Date: Sep. 8, 2016

(54) Single Serve Scoop and Funnel

(71) Applicant: Adrian Rivera, Whittier, CA (US)

(72) Inventor: Adrian Rivera, Whittier, CA (US)

(21) Appl. No.: 14/640,763

(22) Filed: Mar. 6, 2015

(51) Int. Cl. A47J 43/28; G01F 19/00

(52) U.S. Cl. CPC A47J 43/28; G01F 19/002

(57) ABSTRACT

A single serving scoop and funnel both conveniently measures a correct amount of brewing extract, and facilitates pouring the measured beverage extract into a single serving holder. The funnel is moveably attached to a scoop handle, and may be moved between a first position over the scoop, and a second position withdrawn from the scoop. In one embodiment the funnel is hingedly attached to the scoop handle and rotates 180 degrees to latch opposite to the scoop. In another embodiment the funnel slides along the handle away from the scoop.

### BACKGROUND OF THE INVENTION

The present invention relates to preparing a single serving of brewed drink and in particular to a single serving sized scoop for measuring brewing extract and cooperating funnel facilitating pouring the brewing extract into a small brewing cartridge.

Single serving beverage brewers have become extremely popular. Originally, these brewers were designed to use a disposable single serving cartridge. The cost of the disposable single serving cartridges, and the resulting volume of non-biodegradable material has motivated the development of reusable holders which accept a single serving of brewing extract and fit into the single serving beverage brewers. While such holders have become very popular, one drawback is that in order to fit into brewing chambers of the single serving beverage brewers, the holders are small, and it is difficult to pour a single serving of brewing extract into the holders with some of the brewing extract spilling.

Known designs such as disclosed in U.S. Pat. No. 7,441,676 to Pickering and US Patent Application Publication No. 2014/0083555 to Allen show a funnel hingedly attached to a side of a scoop, extending at about a 45 degree angle from a handle. While such designs are suitable for some applications, they are not suitable for scooping brewing extract from typical brewing extract containers because the funnel interferes with scooping the brewing extract.

### BRIEF SUMMARY OF THE INVENTION

The present invention addresses the above and other needs by providing a single serving scoop and funnel which both conveniently measures a correct amount of brewing extract, and facilitates pouring the measured beverage extract into a single serving holder. The funnel is moveably attached to a scoop handle, and may be moved between a first position over the scoop, and a second position withdrawn from the scoop. In one embodiment the funnel is hingedly attached to the scoop handle and rotates 180 degrees to latch opposite to the scoop. In another embodiment the funnel slides along the handle away from the scoop.

In accordance with one aspect of the invention, there is provided a single serving scoop and funnel having a pivoting funnel. A hinge at the base of a funnel arm engages a midpoint of the scoop handle, and the funnel pivots 180 degrees to a position opposite to the scoop and snaps into place. The length of the scoop handle is free for grasping and the funnel does not interfere with scooping brewing extract.

In accordance with one aspect of the invention, there is provided a single serving scoop and funnel having a sliding funnel. The funnel slides along the scoop handle from a position over the scoop for pouring to a position separated from the scoop for scooping. When the funnel is separated from the scoop, the funnel does not interfere with scooping brewing extract.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a scoop scooping brewing extract from a container.

FIG. 2 shows the scoop pouring the brewing extract into an extract holder.

FIG. 3A shows a perspective view of single serving scoop and pivoting funnel according to the present invention.

FIG. 3B shows perspective view of the single serving scoop and pivoting funnel according to the present invention with the funnel partially pivoted away from the scoop.

FIG. 3C shows a perspective view of the single serving scoop and pivoting funnel according to the present invention with the funnel fully pivoted to reside opposite to the scoop.

FIG. 4A shows a side view of the single serving scoop and pivoting funnel according to the present invention with the funnel residing over the scoop.

FIG. 4B shows a side view of the single serving scoop and pivoting funnel according to the present invention with the funnel fully pivoted to reside opposite to the scoop.

FIG. 5A shows a perspective view of a single serving scoop and sliding funnel according to the present invention with the funnel residing over the scoop.

FIG. 5B shows a perspective view of the single serving scoop and sliding funnel according to the present invention with the funnel residing over a scoop handle.

FIG. 6A shows a side view of the single serving scoop and sliding funnel according to the present invention with the funnel residing over the scoop.

FIG. 6B shows a side view of the single serving scoop and sliding funnel according to the present invention with the funnel residing over the scoop handle.

FIG. 7 shows a cross-sectional view of a thumb rest portion of the sliding funnel and a cooperating portion of the scoop handle taken along line 7-7 of FIG. 6A.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

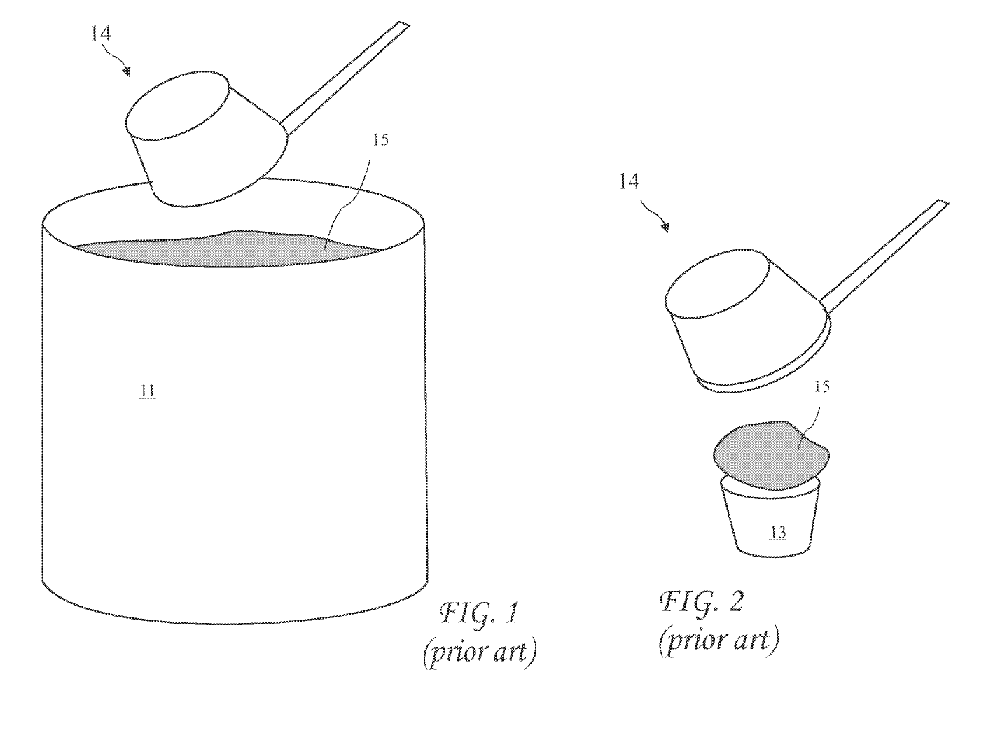

A scoop 14 is shown scooping brewing extract 15 from a container 13 in FIG. 1 and the scoop 14 is shown pouring the brewing extract 15 into an extract holder 13 in FIG. 2. The extract holder 13 is used in a single serving brewer and must fit into the brewing cavity of the brewer, thus limiting the size of the extract holder 13. As a result, it is often difficult to pour the brewing extract 15 into the extract holder 13 without spilling some of the brewing extract.

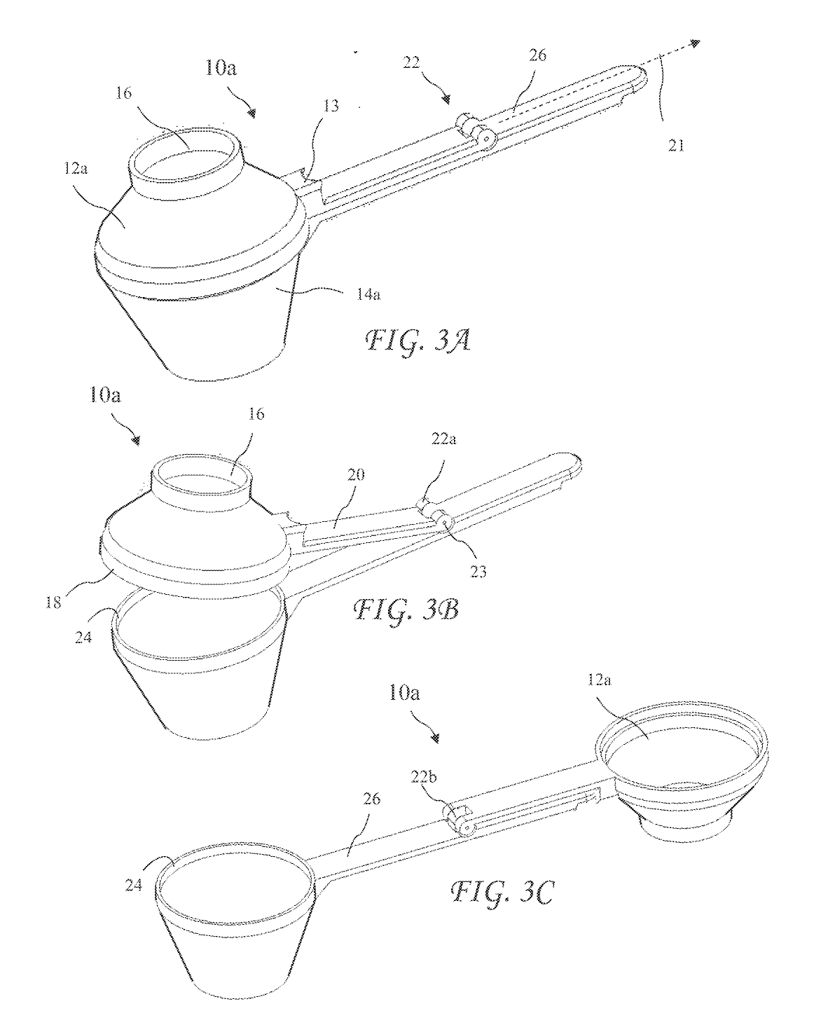

A perspective view of single serving scoop and pivoting funnel 10a according to the present invention is shown in FIG. 3A, a perspective view of the single serving scoop and pivoting funnel 10a with the funnel 12a partially pivoted away from the scoop 14a is shown in FIG. 3B, and a perspective view of the single serving scoop and pivoting funnel 10a with the funnel 12a fully pivoted to reside opposite to the scoop 14a is shown in FIG. 3C. The combination of the scoop 14a and funnel 12a permits pouring brewing extract 15 into the extract holder 13 without spilling the brewing extract. The scoop 14a includes a scoop mouth 24 for scooping the brewing extract 15 from the container 11. The funnel 12a includes a base 18 matched to the scoop mouth 24.

The funnel 12a, and funnel handle 20 rotate around pivot 22 from the position opposite to the scoop 14a for scooping brewing extract, to a position over the scoop 14a for pouring the beverage extract into a holder used in a beverage brewer. The pivot 22 is generally centered on the scoop handle 26 and preferably comprises a scoop handle portion 22a and a funnel handle portion 22b connected by a pin 23. In either position, the funnel handle 20 rests against a scoop handle 26, and the act of grasping the scoop handle 26 holds the funnel 12a in position. The scoop handle reaches in a handle direction 21 from the scoop 14a.

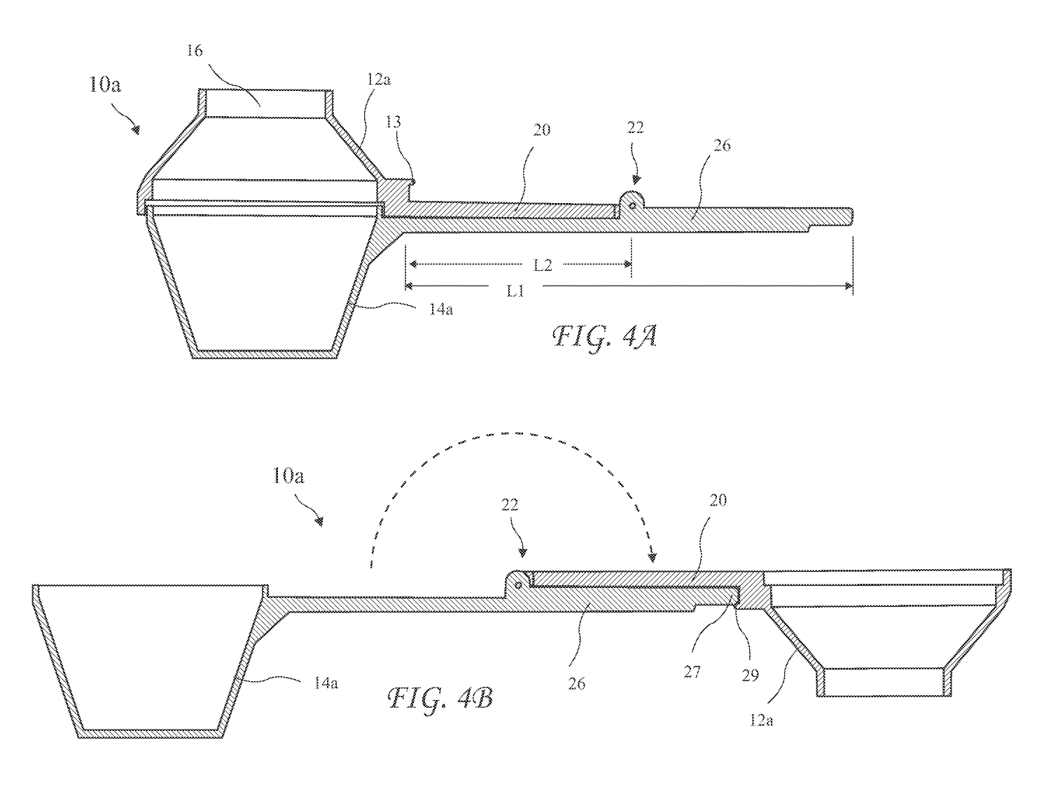

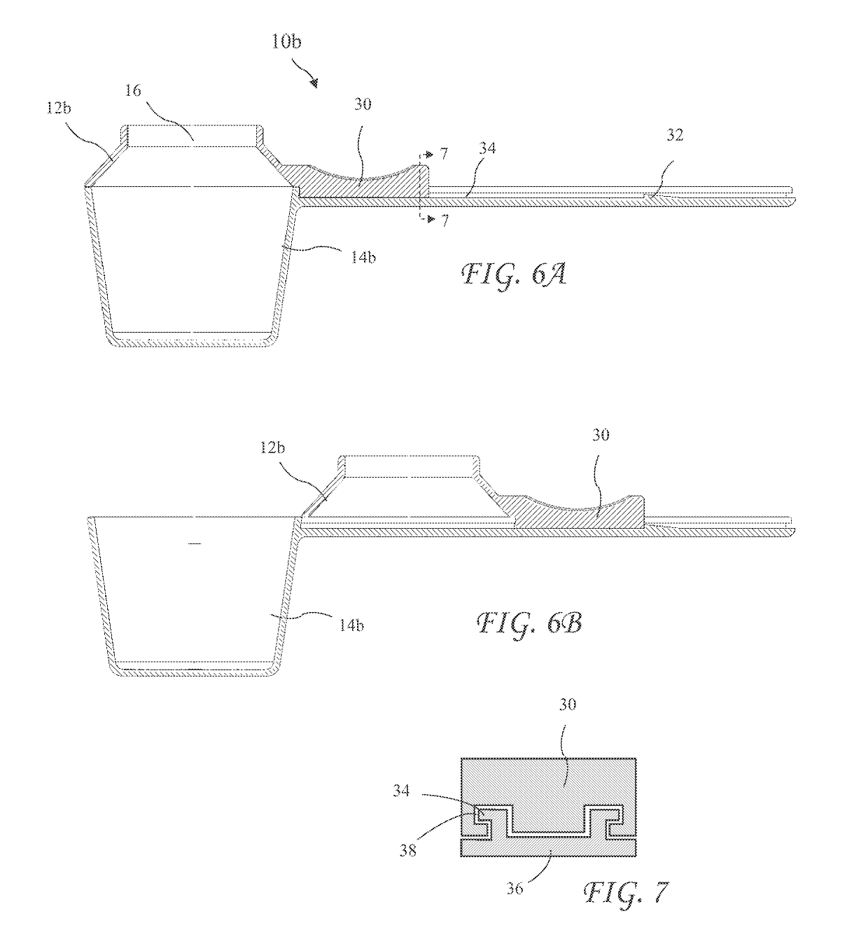

A side view of the single serving scoop and pivoting funnel 10a with the funnel 12a residing over the scoop 14a is shown in FIG. 4A, and a side view of the single serving scoop and pivoting funnel 10a with the funnel 12a fully rotated around the pivot 22 to reside opposite to the scoop 14a is shown in FIG. 4B. The funnel 12a includes a tab 29 projecting towards the pivot 22, and in the fully rotated position of FIG. 6B, the tab 29 overlaps a scoop handle end 27 of the scoop holding the funnel 12a, to hold the funnel 12a in the fully rotated position. The scoop handle 26 has a length L1 of preferably between three and five inches, and more preferably four inches. The funnel handle 20 has a length L2 of preferably between 1.5 and 2.5 inches and more preferably two inches, and the length L2 is preferably about half the length L1, the length L2 being selected to facilitate the cooperation of the tab 29 with the handle end 27 to hold the pivoting funnel 12a in the separated position.

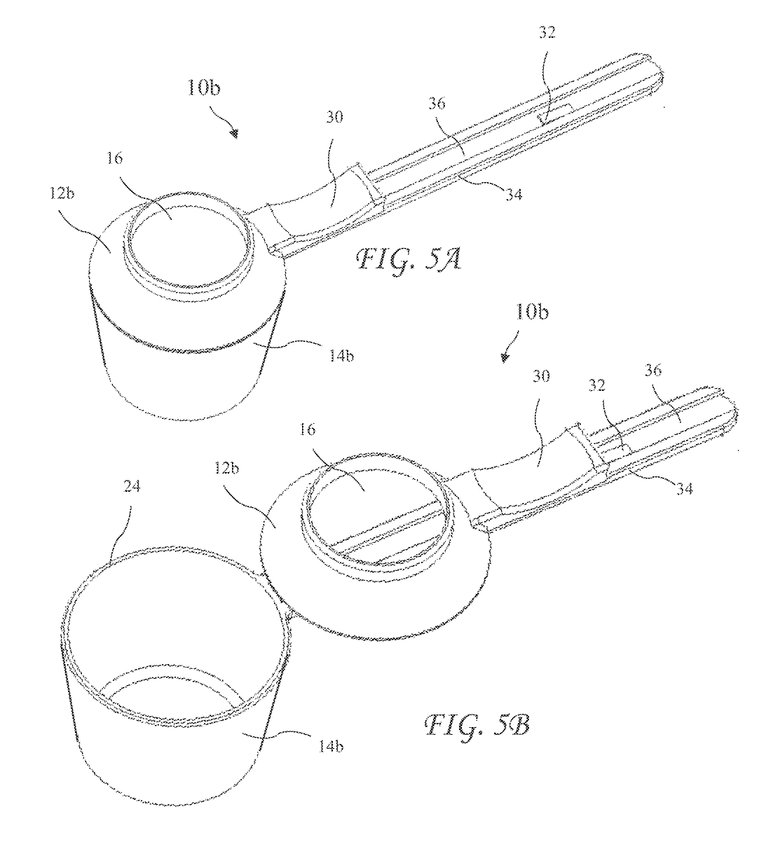

A perspective view of a single serving scoop and sliding funnel 10b according to the present invention with sliding funnel 12b residing over a scoop 14b is shown in FIG. 5A and a perspective view of the single serving scoop and sliding funnel 10b is shown in FIG. 5B. The funnel 12b slides on the scoop handle 36 from a first position over the scoop 14b for pouring brewing extract 15 into the extract holder 13, to a second position separated from the scoop 14b for scooping the brewing extract 15 from the container 11. The scoop handle 36 includes rails 34 engaged by slots 38 (see FIG. 7) in a thumb rest 30 of the funnel 12b. A stop 32 on the scoop handle 36 lim its the sliding of the sliding funnel 12b. The sliding funnel 12b is just past the scoop mouth 24 when the thumb rest 30 touches the stop 32.

A side view of the single serving scoop and sliding funnel 10b is shown in FIG. 6A and a side view of the single serving scoop and sliding funnel 10b with the sliding funnel 12b residing over the scoop handle 36 is shown in FIG. 6B.

A cross-sectional view of the thumb rest portion 30 of the sliding funnel 12b and a cooperating portion of the scoop handle taken along line 7-7 of FIG. 6A is shown in FIG. 7. The slots 38 in the thumb rest engage the channel 34 of the scoop handle 30 to limit the sliding funnel 12b to sliding motion on the scoop handle 36.

While the invention herein disclosed has been described by means of specific embodiments and applications thereof, numerous modifications and variations could be made thereto by those skilled in the art without departing from the scope of the invention set forth in the claims.

I claim:

1. A single serving brewing extract utensil, comprising:
a scoop having a volume of a single serving of brewing extract and having a scoop mouth;
a scoop handle attached to the scoop and extending in an arm direction; and
a funnel having a base matched to the scoop mouth and a smaller funnel mouth for pouring the single serving of brewing extract into a single serving holder, the funnel moveable from a first position aligning the base of the funnel to the scoop mouth, and a second position displaced in the arm direction and separated from the scoop mouth.

2. The utensil of claim 1, wherein the funnel pivots from the first position to the second position.

3. The utensil of claim 2, wherein the funnel includes a short funnel arm hingedly cooperating with the scoop handle.

4. The utensil of claim 3, wherein the funnel pivots about 180 degrees from the first position to the second position.

5. The utensil of claim 4, wherein the funnel snaps into the second position.

6. The utensil of claim 4, wherein the scoop handle is between three inches and 5 inches long.

7. The utensil of claim 1, wherein the funnel slides along the scoop handle from the first position to the second position.

8. The utensil of claim 7, wherein:
a thumb rest is attached to one side of the funnel and extends parallel with the scoop handle; and
rails are defined along opposite top edges of the scoop handle and the thumb rest includes slots slidably engaging the rails.

9. The utensil of claim 8, wherein a stop is formed on a top surface of the scoop handle and the stop limits the sliding of the funnel along the handle.

10. The utensil of claim 9, wherein the thumb rest contacts the stop when the funnel is separated from the scoop mouth.

11. A single serving brewing extract utensil, comprising:
a scoop having a volume of a single serving of brewing extract and having a scoop mouth;
a scoop handle fixedly attached to the scoop and extending in an arm direction to a scoop handle end, the scoop handle having a length L1 of four inches;
a pivot generally centered on the scoop handle;
a pivoting funnel having a base matched to the scoop mouth and a smaller funnel mouth for pouring the single serving of brewing extract into a single serving holder;
a funnel handle fixedly attached to the pivoting handle at a free end of the funnel handle, the funnel handle rotatable about 180 degrees about the pivot from a first position aligning the base of the funnel to the scoop mouth, to a second position displaced in the arm direction and separated from the pivoting funnel from the scoop mouth, the funnel handle one half the length of the scoop handle; and
a tab extending away from the pivoting funnel towards the pivot, the tab cooperating with a scoop handle end of the scoop handle to hold the pivoting funnel in the second position.

12. A single serving brewing extract utensil, comprising:
a sliding scoop having a volume of a single serving of brewing extract and having a scoop mouth;
a scoop handle having a length of four inches and fixedly attached to the sliding scoop and extending in an arm direction; and
a funnel having a base matched to the scoop mouth and a smaller funnel mouth for pouring the single serving of brewing extract into a single serving holder, the funnel moveable from a first position aligning the base of the funnel to the scoop mouth, and a second position displaced in the arm direction and separated from the scoop mouth;
a thumb rest attached to one side of the funnel and extends parallel with the scoop handle in the arm direction;
rails defined along opposite top edges of the scoop handle and the thumb rest includes slots slidably engaging the rails; and
a stop formed on a top surface of the scoop handle and the stop limits the sliding of the funnel along the handle.
